(19) United States
(12) Patent Application Publication
(10) Pub. No.: US 2026/0357560 A1
(43) Pub. Date: Nov. 12, 2026

(54) Expandable structure, system, and method of use

(71) Applicants: Matthew Neil Carey, Etobicoke (CA); Lara Adelle Spina, Etobicoke (CA)

(72) Inventors: Matthew Neil Carey, Etobicoke (CA); Lara Adelle Spina, Etobicoke (CA)

(21) Appl. No.: 19/276,578

(22) Filed: Jul. 22, 2025

Related U.S. Application Data
(60) Provisional application No. 63/803,742, filed on May 11, 2025.

(51) Int. Cl. E04B 1/344

(52) U.S. Cl. CPC E04B 1/3445

(57) ABSTRACT

An expandable structure includes an enclosure which has a plurality of interconnected panels. Each of the panels of the enclosure are directly and fixedly connected to at least one other panel of the plurality of panels. The enclosure has an expanded configuration and a collapsed configuration. In one embodiment, in the expanded configuration the enclosure is positionable to cover the opening of an entrance and prevent the transfer of contaminants from a contaminated side to a clean side.

### CROSS REFERENCE TO RELATED APPLICATION

This application claims the filing benefit under 35 U.S.C. § 119(e) of U.S. Provisional Application No. 63/803,742, filed May 11, 2025 which is hereby incorporated by reference.

### TECHNICAL FIELD

The present invention pertains generally to expandable structures, and more particularly to an enclosure which expands from a collapsed configuration to an expanded configuration. In one embodiment the enclosure can be utilized as a temporary contamination barrier which prevents construction, biological, or other contaminants from passing from one side of an entrance to the other side.

### BACKGROUND OF THE INVENTION

Current standards and best practices in healthcare (reference CSA Z317.13.22 and similar) and other industries require that dirty areas, in particular construction areas, be separated from adjacent areas with administrative controls, physical barriers and controlled conditioned filtered airflow. These requirements are mandated to prevent contamination from dirty areas entering adjoining clean areas and become particularly challenging to apply in emergent situations where time is of the essence. Within a healthcare or senior care facility setting these measures are imperative to ensure the health and safety of at risk groups, such as patients whom are immune compromised.

The traditional approaches to construction or fabrication of containment structures utilize a design of multiple sperate parts and pieces which are then manually assembled on site. These parts are often expensive, bulky and heavy to transport, requiring specialized vehicles and more than one person to handle. Similarly, assembly of these parts into a complete erected containment structure takes considerable amounts of time and a team of relatively skilled labor. The resulting containments are difficult to fully seal and are often not equipped to best comply with required standards.

### BRIEF SUMMARY OF THE INVENTION

The present invention is directed to an expandable structure which includes an enclosure which can be folded and unfolded between a compact collapsed form and an expanded cuboid form, an Infection Prevention Automatic Containment Kit or I.P.A.C.K. The compact, folded form provides an easily transportable package which is lightweight, small enough to be handled by one person, and able to fit in a standard automobile. The expanded, unfolded form provides a structurally stable, sealed room with top, bottom, side, front, and rear panels. The transition between the collapsed and expanded forms can be effected using a blower which serves to either inflate or deflate the enclosure. The enclosure can also be deployed by pulling the form open from two opposite ends or sides and where the folded shape actuates open in a single motion and without multiple manipulations. The enclosure has conjoined panels which form a rigid cuboid structure.

The resulting sealed enclosure is adaptable and easily customized to suit many purposes. In one embodiment as further described herein, the enclosure can serve as a contamination barrier between “clean” and “dirty” sides of an entrance such as a doorway. However the enclosure is not limited to this embodiment alone. Other possible embodiments include shelters, temporary shelters, emergency shelters, storage structures, outdoor recreation or work structures, privacy partitions, modular tents, storage sheds, greenhouses, transportation containers, and the like.

In the collapsed and folded form the enclosure provides a compact, transportable package measuring approximately 2′×3.5′×10″, and weighing less that 30 lbs, noting that the folded form can be produced in various sizes and weights of material. In the expanded form the enclosure provides enough space to receive an erect human, or a human laying horizontal if the cuboid is positioned on it's side.

In accordance with an embodiment, an expandable structure includes an enclosure which has a plurality of interconnected panels. Each panel of the plurality of panels is directly and fixedly connected to at least one other panel of the plurality of panels. The enclosure has an expanded configuration and a collapsed configuration.

In accordance with another embodiment, in the expanded configuration the enclosure has a cuboid shape.

In accordance with another embodiment, the enclosure has a service connection point. An internal blower is connected to the service connection point. The internal blower is usable to place the enclosure in the expanded configuration or in the collapsed configuration.

In accordance with another embodiment, the enclosure has a service connection point. An external blower is connected to the service connection point. The external blower is usable to place the enclosure in the expanded configuration or in the collapsed configuration.

In accordance with another embodiment, the plurality of panels includes a first side panel, a second side panel, a front panel, a rear panel, a top panel, and a bottom panel.

In accordance with another embodiment, the first side panel, the second side panel, the front panel, the rear panel, the top panel, and the bottom panel each have at least one fold line. The first side panel and the second side panel each have a central fold line which has a first end and an opposite second end. First and second angled fold lines emanate from the first end of the central fold line, and third and fourth angled fold lines emanate from the second end of the central fold line.

In accordance with another embodiment, the top panel is fixedly connected to the first side panel and to the second side panel. The bottom panel is fixedly connected to the first side panel and to the second side panel.

In accordance with another embodiment, the front panel is fixedly connected to the first side panel by a first hinge.

In accordance with another embodiment, the front panel has a first connector. The first connector is removably connectable to the second side panel or to the first side panel.

In accordance with another embodiment, the rear panel is fixedly connected to the second side panel by a second hinge.

In accordance with another embodiment, the rear panel has a second connector. The second connector is removably connectable to the first side panel or to the second side panel.

In accordance with another embodiment, the enclosure has a longitudinal axis. A locking panel is pivotally connected to at least one of the top panel and the bottom panel. The locking panel is positionable to an unlocked position parallel to the longitudinal axis, and to a locked position perpendicular to the longitudinal axis. It can be appreciated that the locking panels could also connect on the side panels (like a second inner door that opens in).

In accordance with another embodiment, a ramp is pivotally connected to the bottom panel. The ramp is positionable to an inwardly projecting stowed position and to an outwardly projecting deployed position.

In accordance with another embodiment, the ramp has a top surface. A dust collector is disposed on the top surface of the ramp.

In accordance with another embodiment, the bottom panel has a bottom side. An adhesive is disposed on the bottom side of the bottom panel.

In accordance with another embodiment, the enclosure has a front side. A front wall is disposed at the front side. A front closure disposed in the front wall. The front closure includes a front door.

In accordance with another embodiment, the enclosure has a rear side. A rear wall is disposed at the rear side. A rear closure is disposed in the rear wall. The rear closure includes a rear door;

In accordance with another embodiment, the expandable structure cooperates with an entrance, the enclosure has a rear side. A flexible flange is disposed at the rear side ;. The flexible flange has an adhesive strip. The adhesive strip is connectable to the entrance.

In accordance with another embodiment, the expandable structure cooperates with an entrance, a plurality of tethers are connected to the enclosure. The plurality of tethers are connectable to the entrance.

Other embodiments, in addition to the embodiments enumerated above, will become apparent from the following detailed description, taken in conjunction with the accompanying drawings, which illustrate, by way of example, the principles of the expandable structure, system, and method of use.

### BRIEF DESCRIPTION OF THE DRAWINGS

FIG. 1 is a front perspective view of an enclosure having a front panel in a closed position;

FIG. 2 is a bottom plan view of FIG. 2;

FIG. 3 is a rear perspective view of the enclosure showing a rear panel in a closed position;

FIG. 3A is a rear perspective view as in FIG. 3 showing a flap and connector before closure;

FIG. 4 is a bottom plan view of FIG. 3;

FIG. 5 is a front perspective view of the enclosure showing the front panel in an open position;

FIG. 5A is a front perspective view as in FIG. 5 showing the flap and connector before closure;

FIG. 6 is a bottom plan view of FIG. 5;

FIG. 7 is a rear perspective view of the enclosure showing the rear panel in an open position;

FIG. 8 is a bottom plan view of FIG. 7;

FIG. 9 is a reduced front elevation view of the enclosure;

FIG. 10 is a reduced front elevation view of the enclosure showing a front door in an open position;

FIG. 11 is a reduced front perspective view showing a ramp in an outwardly projecting deployed position;

FIG. 12 is a reduced rear elevation view of the enclosure;

FIG. 13 is a reduced rear elevation view of the enclosure showing a rear door in an open position and a locking panel in an unlocked position;

FIG. 14 is a reduced rear elevation view of the enclosure showing the locking panel in a locked position;

FIG. 15 is a cross sectional view along the line 15-15 of FIG. 14;

FIG. 16 is a rear perspective view of the enclosure showing a flexible flange;

FIG. 17 is a reduced side elevation view showing two enclosures connected by the flexible flange of one of the enclosures;

FIG. 18 is a reduced front perspective view of a prior art entrance;

FIG. 19 is a reduced front perspective view showing the enclosure installed at the entrance;

FIG. 20 is a reduced rear perspective view of the entrance and enclosure;

FIG. 21 is a reduced perspective view of the enclosure in a collapsed configuration;

FIG. 22 is a reduced perspective view of the enclosure in a folded state;

FIG. 23 is a reduced perspective view of the enclosure in a first unfolded state;

FIG. 24 is a reduced perspective view of the enclosure in a second unfolded state;

FIG. 25 if a reduced perspective view of the enclosure in a third unfolded state;

FIG. 26 is a reduced perspective view of the enclosure unfolded in the expanded configuration;

FIG. 27 is a first air flow diagram with an internal blower;

FIG. 28 is a second air flow diagram with an external blower;

FIG. 29 is a third air flow diagram;

FIG. 30 is a fourth air flow diagram;

FIG. 31 is a fifth air flow diagram;

FIG. 32 is a sixth air flow diagram; and,

FIG. 33 is a seventh air flow diagram.

### DETAILED DESCRIPTION OF THE INVENTION

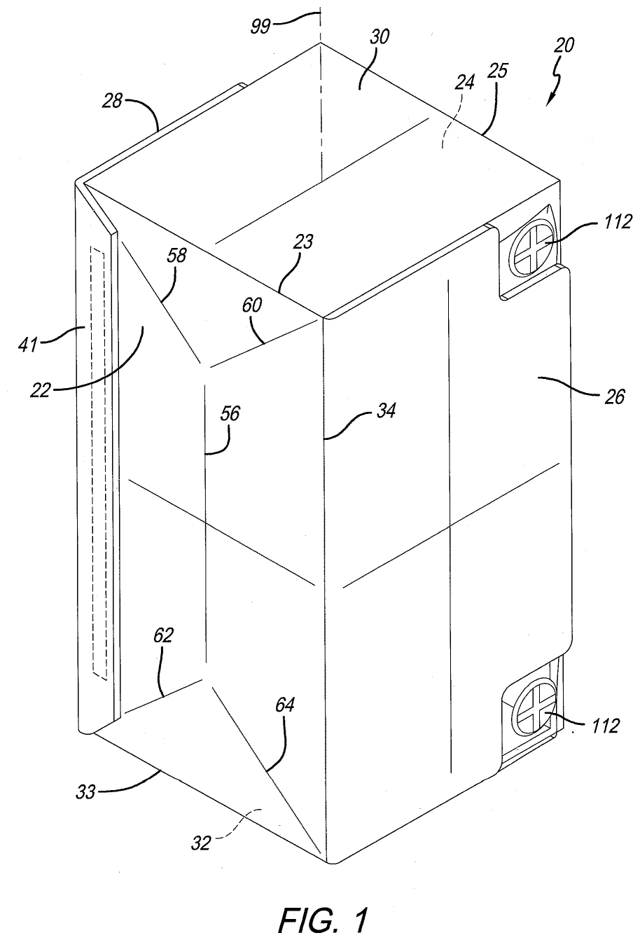

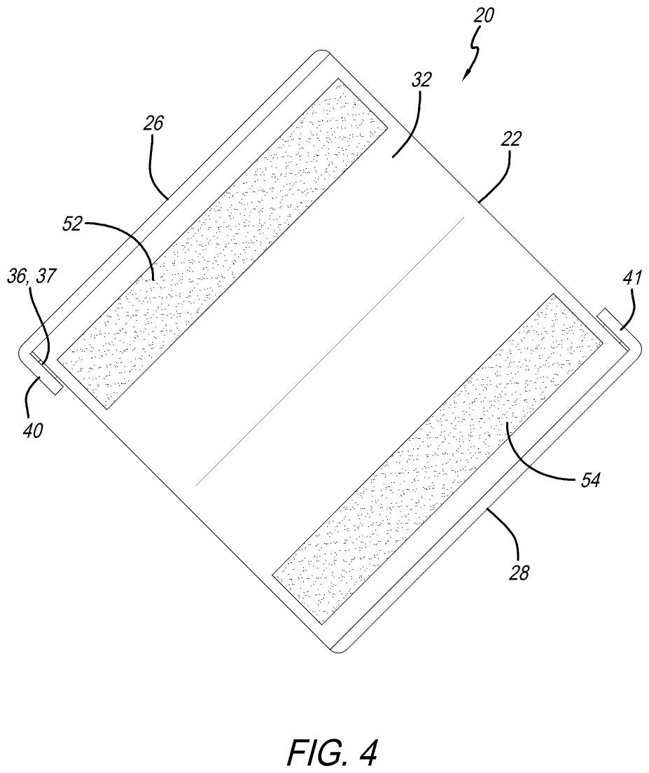

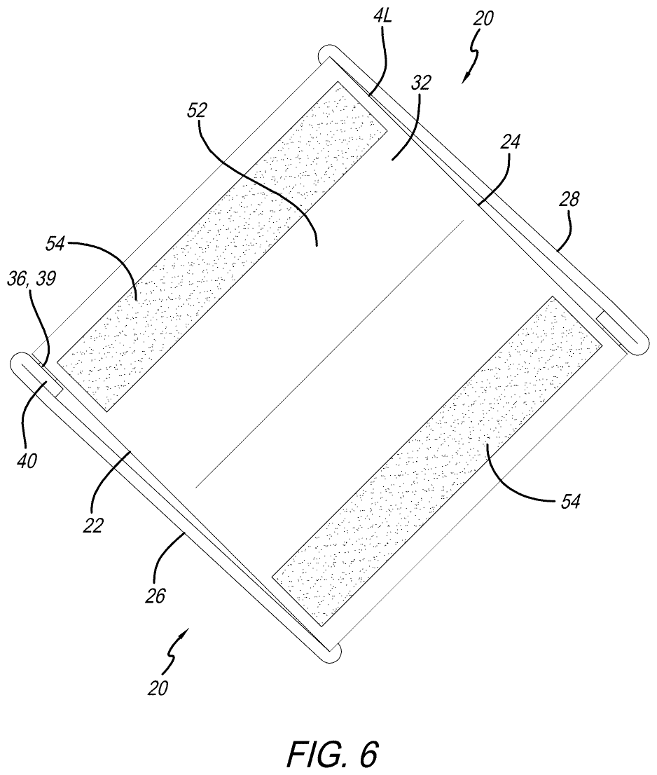

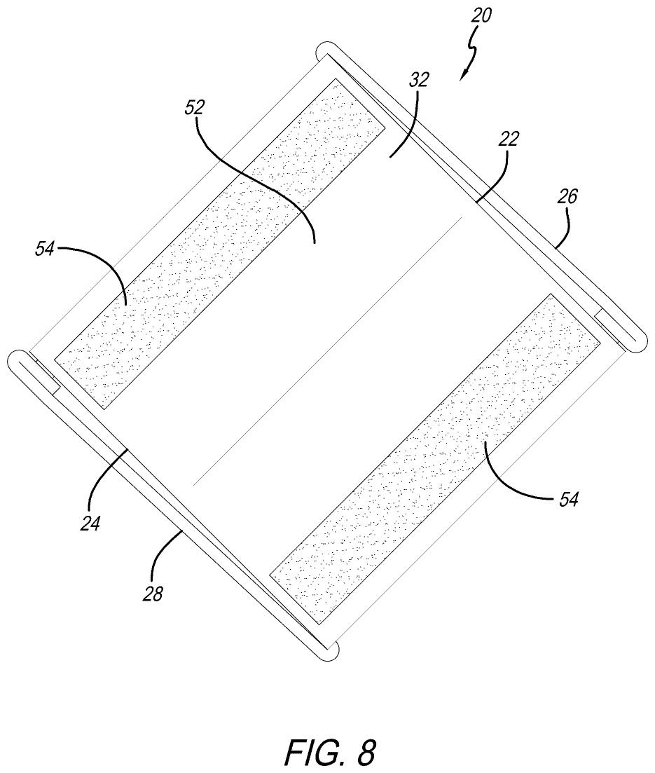

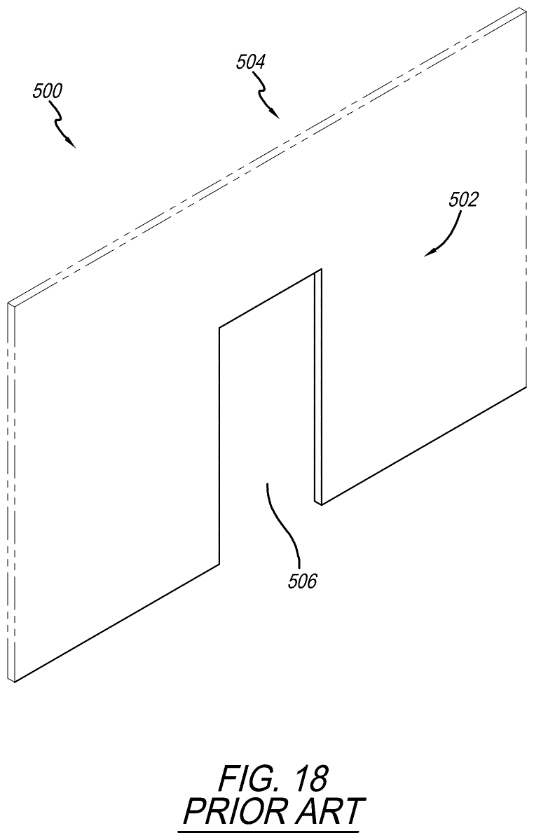

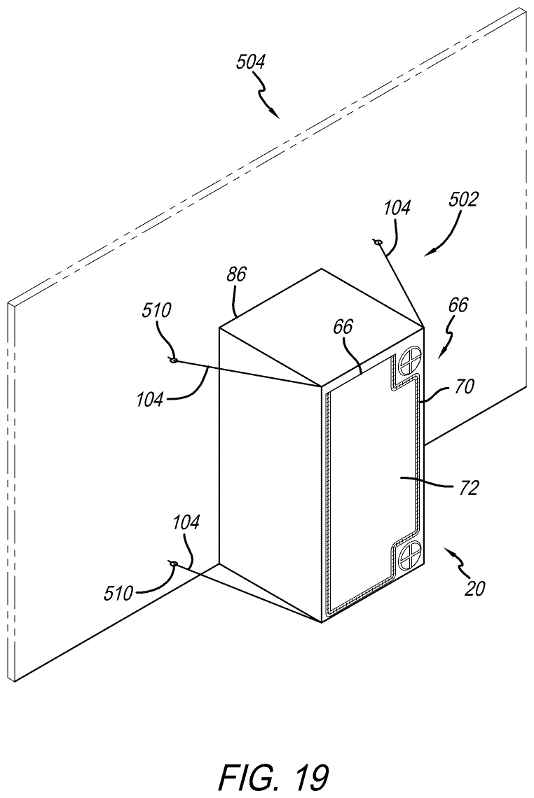

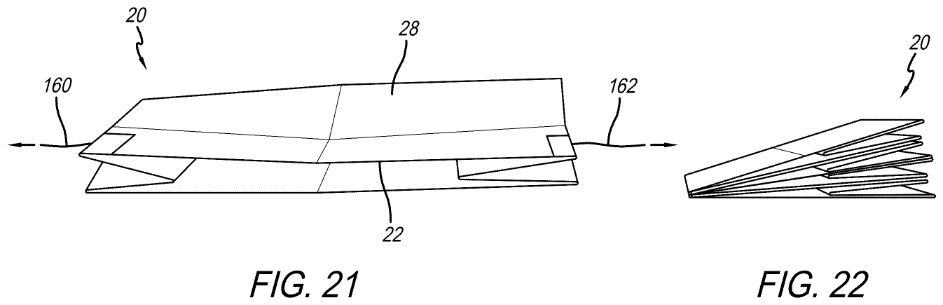

Referring initially to FIGS. 1-8 there are illustrated front perspective, rear perspective, and bottom plan views of an expandable structure which includes an enclosure 20 which has a plurality of interconnected panels, wherein each panel of the plurality of interconnected panels is directly and fixedly connected to at least one other panel. As used herein the term “directly and fixedly connected” means that the interconnecting panels abut each other and that the connection is permanent rather than being removeable or temporary, thus forming an integral hinge. Enclosure 20 has an expanded configuration as shown in FIGS. 1-8, and a collapsed configuration as shown in FIG. 21. In one possible embodiment, In the expanded configuration enclosure 20 is positionable to cover an opening 506 in an entrance 500 as is shown in FIGS. 18-20. When so positioned, enclosure 20 prevents the spread of contamination from one side of the entrance 500 to the other side.

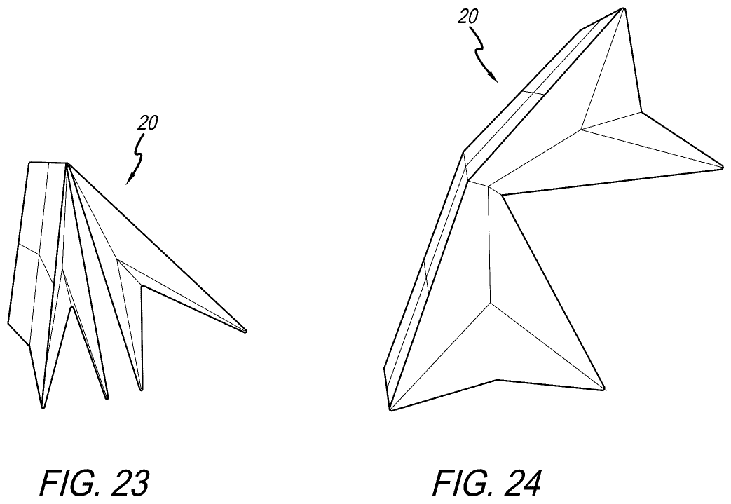

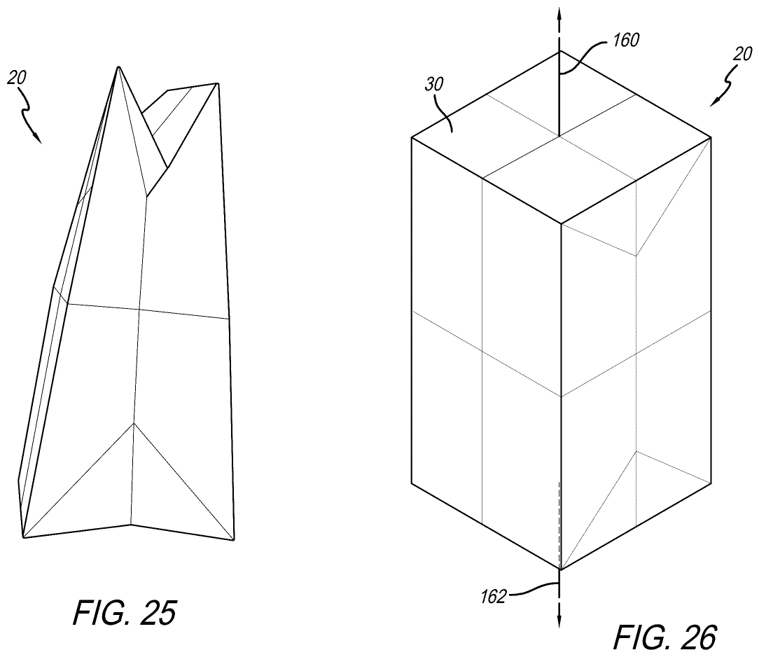

In the expanded configuration enclosure 20 has a cuboid shape, and is sized and dimensioned to permit a person to enter. In one embodiment enclosure 20 is 7.5 feet tall, 4.0 feet wide, and 3.9 feet deep. In certain embodiments enclosure 20 has exactly six sides, is airtight, and does not include an internal airbag. Further, when collapsed enclosure 20 may be folded multiple times into a package form which is suitable for carrying (refer to FIGS. 22-26).

The panels of enclosure 20 can be constructed of any suitable sheet materials, which may be layered, painted, coated or imparted with additional properties such as fire retardant, insulating, UV protectant or decorative exterior (to name a few) to suit the need of the application. In an embodiment the panels are made of corrugated or honeycomb type PP plastic (commonly sold under the trade name Coroplast™) 4 mm-8 mm weight, stock 4×8 sheets. The sheets are cut, folded and sealed together to form the complete enclosure 20 shell; intended crease lines are stressed with compression to allow for easy folding, the enclosure 20 shell is then exposed to an vacuum to allow for “deflation” the first time, pulling the form into the compact state and thus molding its final construction (refer to FIG. 21). It can be appreciated that any materials which are suitable foldable and fusible could also be used to construct embodiments.

The plurality of panels include a first side panel 22, a second side panel 24, a front panel 26, a rear panel 28, a top panel 30, and a bottom panel 32. Top panel 30 is fixedly connected to first side panel 22 (at edge 23) and to second side panel 24 (at edge 25). Bottom panel 32 is fixedly connected to first side panel 22 (at edge 33) and to second side panel 24 (at edge 35). Referring to FIGS. 1-4, front panel 26 is fixedly connected to first side panel 22 by a first hinge 34.

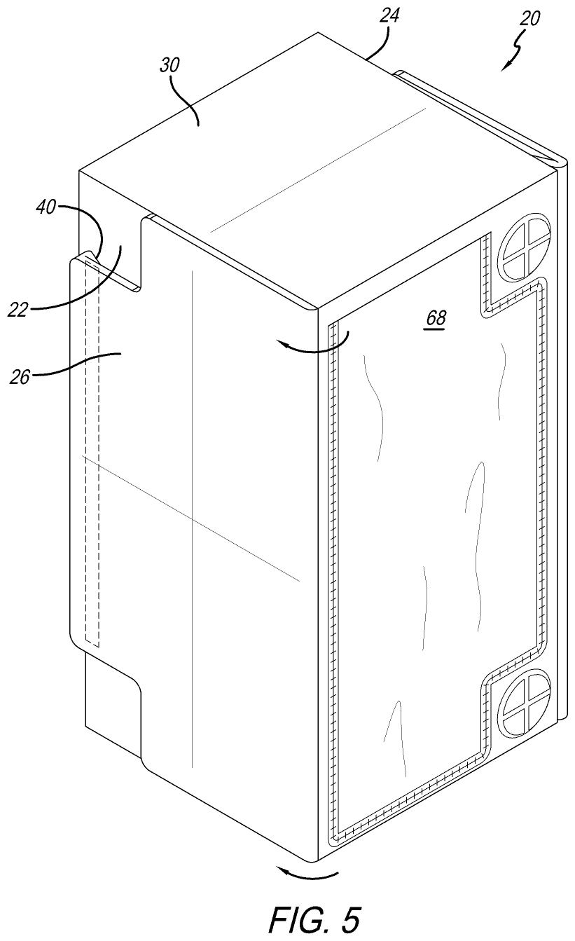

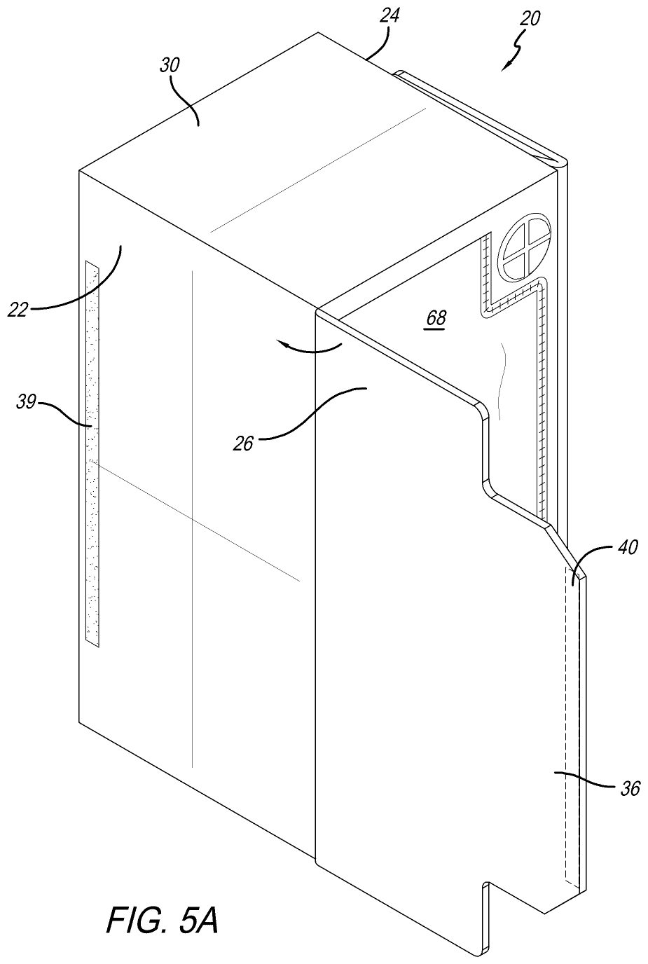

Front panel 26 is rotatable from the closed position of FIG. 1 to the open position of FIG. 5. That is, after enclosure 20 is placed in the expanded position of FIG. 1, front panel 26 may be moved (opened) to allow access to the inside of enclosure 20 as is shown in FIG. 5. To do this, front panel 26 is rotated from the position of FIG. 1 where it connects to second side panel 24 to the position of FIG. 5 where it connects to first side panel 22. The position of FIG. 5 serves to strengthen enclosure 20 and hold it in the expanded configuration.

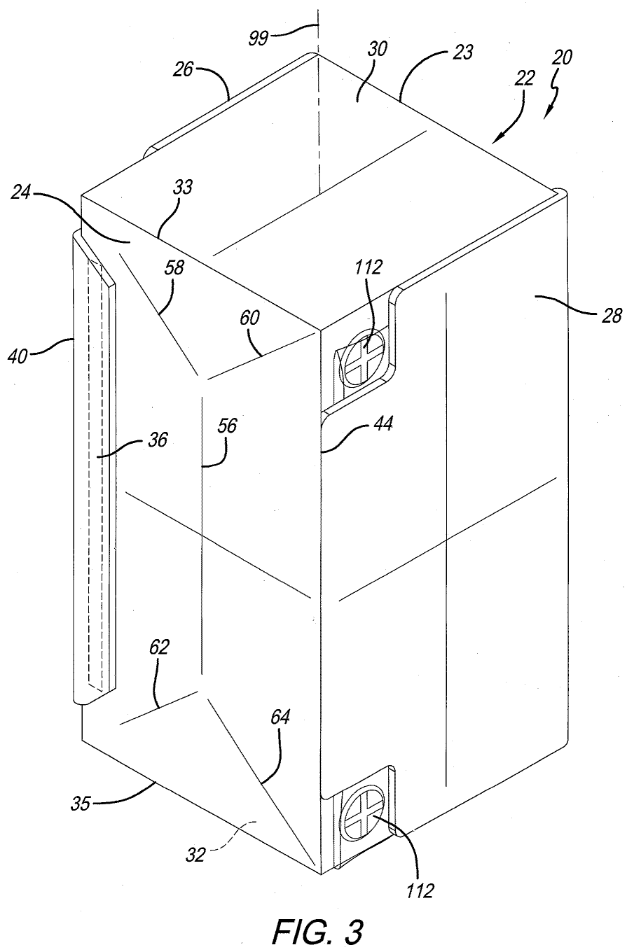

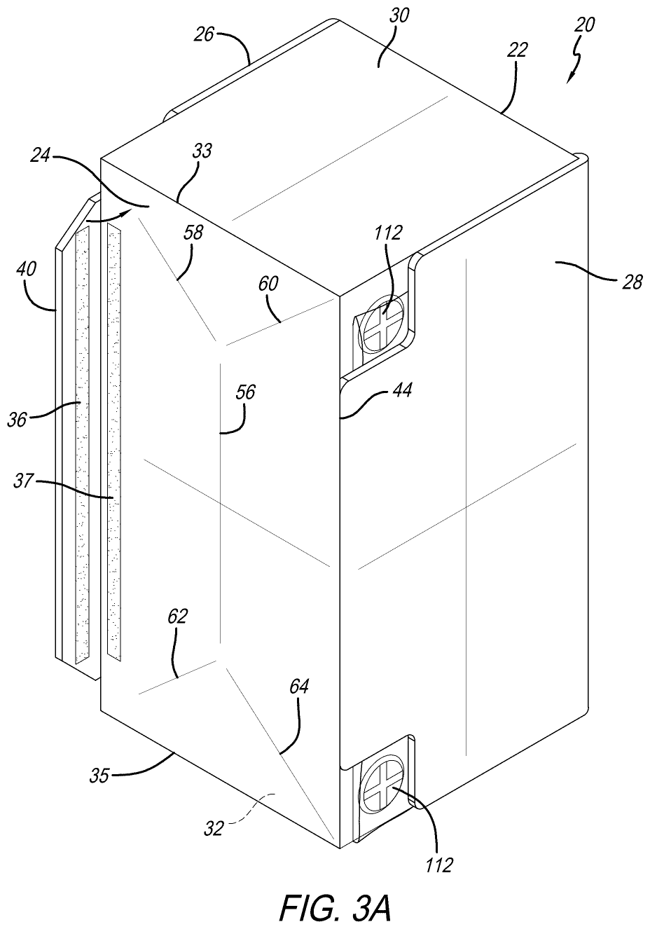

Referring to FIGS. 3 and 3A it is noted that front panel 26 has a hinged flap 40 which has an elongated first connector 36. First connector 36 removably connects to an elongated second connector 37 disposed on second side panel 24. In the shown embodiment first 36 and second 37 connectors are cooperating hook and loop connectors. FIG. 3 shows first 36 and second 37 connectors connected, and FIG. 3A shows flap 40 being rotated to make the connection. Of course it may be appreciated that other forms of connection could also be utilized.

Referring to FIG. 5 front panel 26 has been rotated from the closed position of FIG. 1 to the open position of FIG. 5. Flap 40 has been folded back so that elongated first connector 36 connects to an elongated third connector 39 disposed on first side panel 22. FIG. 5A shows first panel 26 being rotated with tolded-back flap 40.

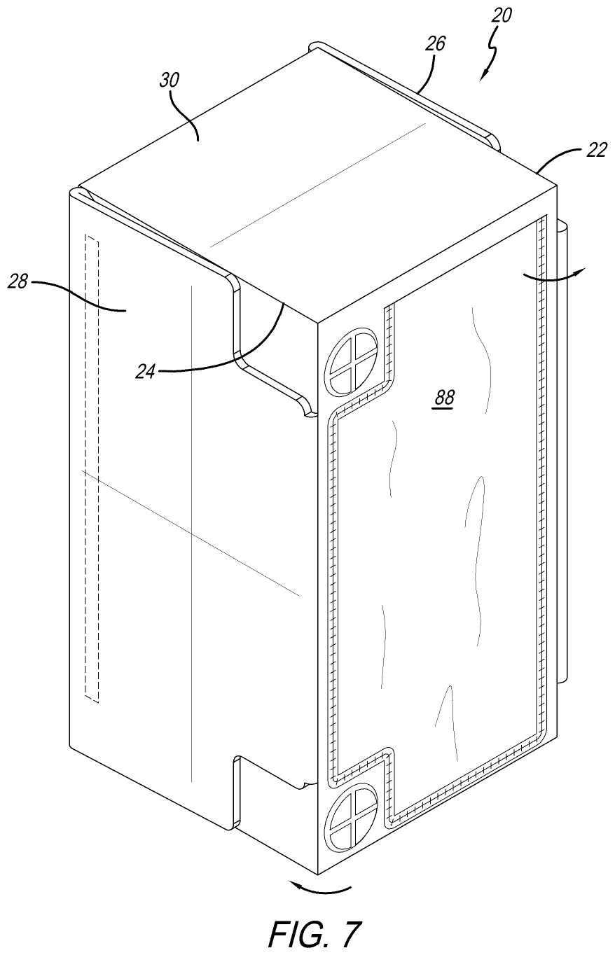

Similar to front panel 26 discussed above rear panel 28 is fixedly connected to second side panel 24 by a second hinge 44, and is rotatable from the closed position of FIG. 3 to the open position of FIG. 7. Rear panel 28 has a rear flap 41 (refer to FIG. 1) similar to front flap 40 of front panel 26. Rear panel 28 opens, closes, and connects to the side panels in the same manner as that described above for front panel 26.

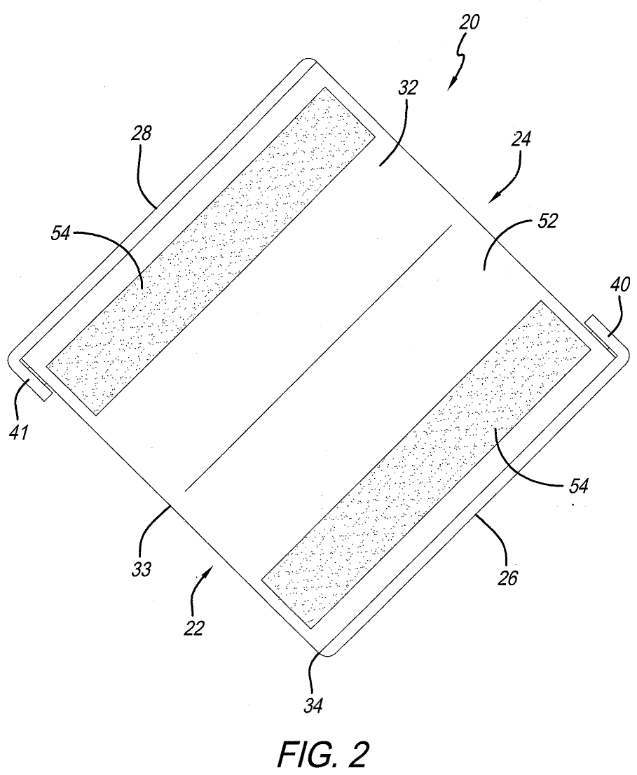

Referring to FIGS. 2, 4, 6, and 8 it is noted that bottom panel 32 has a bottom side 52 upon which an adhesive 54 is disposed. Adhesive 54 adheres to the floor at entrance 500 to hold enclosure 20 in place. In the shown embodiment adhesive 54 is peel-back and has multiple layers to allow multiple positionings of enclosure 20.

Each of the panels has at least one fold line so that enclosure 20 can be folded into a portable package (refer to FIGS. 1 and 3). For example, first side panel 22 and second side panel 24 each have a central fold line 56 having a first end and an opposite second end. First 58 and second 60 angled fold lines emanating from first end of central fold line 56, and third 62 and fourth 64 angled fold lines emanating from second end of central fold line 56. Other panels have fold lines as well as is shown in FIGS. 1 and 3 respectively.

Referring now to FIGS. 9-10, there are shown front elevation views of enclosure 20 with front panel 26 in the open position of FIG. 5. Enclosure 20 has a front side 66. A front wall 68 is disposed at front side 66. In an embodiment front wall 68 is fabricated from a polymer sheet which is connected to first side panel 24, second side panel 26, top panel 30, and bottom panel 32. (refer to FIG. 1) The connection forms an air tight seal at front side 66 so that air is prevented from entering or leaving enclosure 20. To effect entry into enclosure 20, front wall 68 includes a front closure 70 which includes a front door 72. In the shown embodiment front closure 70 (shown closed in FIG. 9) is a zipper (with double pull tabs on both sides) which when opened (FIG. 10) creates a front door 72 (a flap as shown) through which a user may enter or exit enclosure 20. It may be appreciated however that other closure means such as weatherstripping seals, hook and loop fasteners, interlocking cables, pneumatic pressure, heat, light, static electricity, strands, coils, peas shoot tendrils, friction fit and or adhesives/pre-backed adhesive strips, or the like could also be utilized. In another embodiment the lower portion 74 of closure 70 (zipper) is replaced with a magnetic strip (not shown) which cooperates with magnetic material disposed at the bottom of enclosure 20 to effect closure.

Referring now to FIGS. 10-11, a ramp 80 is pivotally conned to bottom panel 32 (refer to FIG. 2). Ramp 80 is rotatably positionable to an inwardly projecting stowed position as is shown in FIG. 10, and to an outwardly projecting deployed position as shown in FIG. 11. Ramp 80 has a top surface 82. A dust collector such as of microfiber or an adhesive is disposed on top surface 82 of ramp 80. That is, when ramp 80 is in the outwardly projecting deployed position of FIG. 11, top surface faces upward so that dust collector 84 can remove dust and other materials from the shoes of entering personnel. In effect ramp 80 serves as a folding “draw bridge” which can selectively deployed to both collect unwanted materials and in some embodiments protect a portion of closure 70. Additionally when in the deployed position of FIG. 11, ramp 80 serves to cover and protect the bottom portion of closure 20 from foot traffic. It may be appreciated that a fold down ramp can also be disposed at the rear side of enclosure 20.

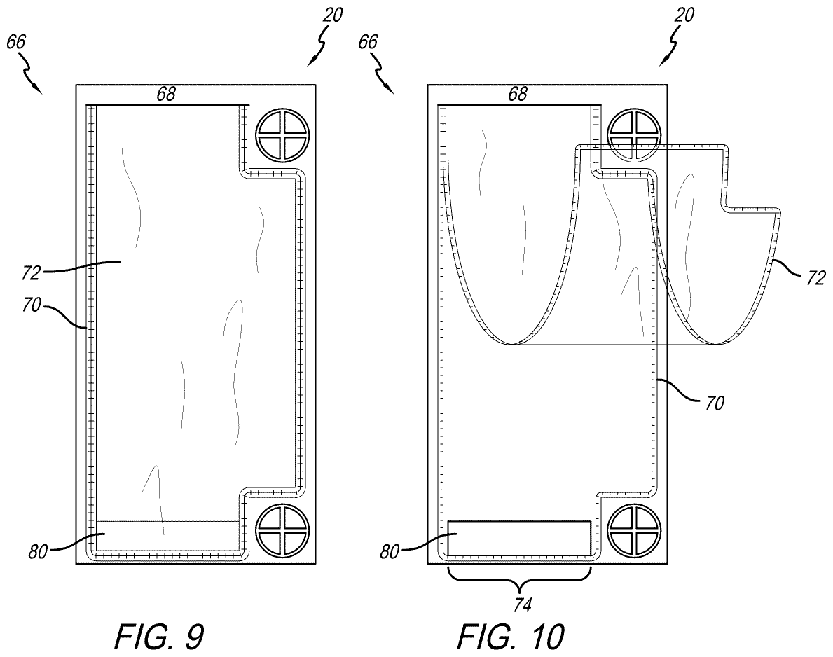

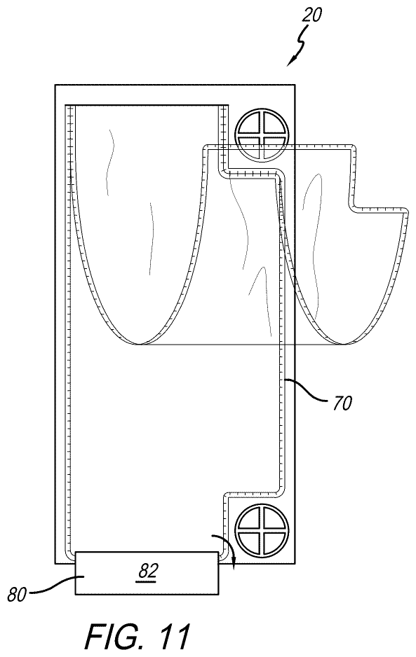

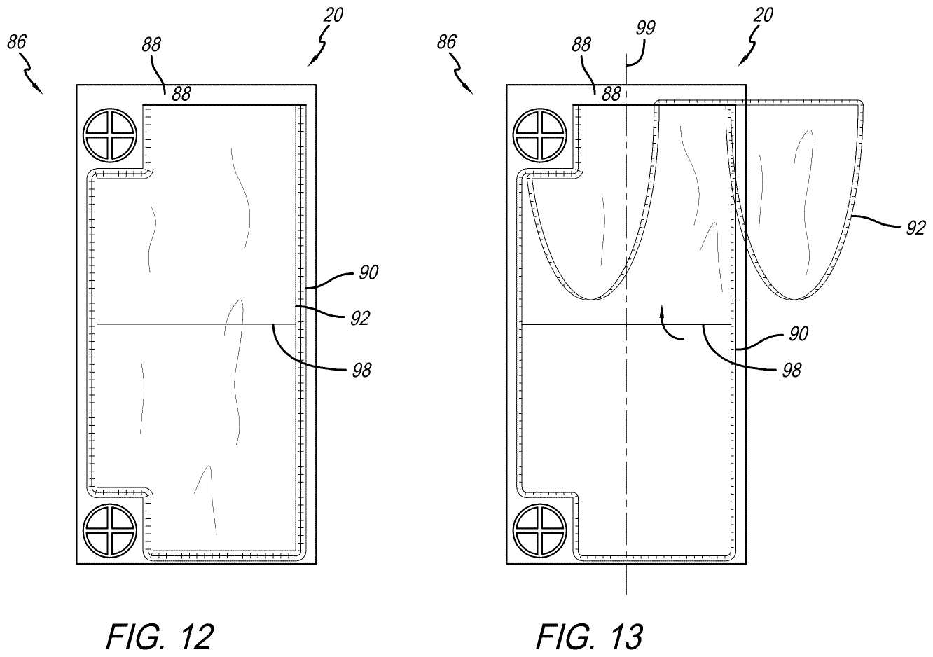

Referring now to FIGS. 12-15, there are shown rear elevation and cross sectional views of enclosure 20 with rear panel 28 in the open position of FIG. 7. Enclosure 20 has a rear side 86. A rear wall 88 is disposed at rear side 86. In an embodiment rear wall 88 is fabricated from a polymer sheet which is connected to second side panel 24, first side panel 22, top panel 30, and bottom panel 32. The connection forms an air tight seal at rear side 86 so that air is prevented from entering or leaving enclosure 20. To effect entry into enclosure 20, rear wall 88 includes a rear closure 90 which includes a rear door 92. In the shown embodiment rear closure 90 (shown closed in FIG. 12) is a zipper (with pull tables on both sides) which when open (FIG. 13) creates a frear door 92 (a flap as shown) which a user may enter or exit enclosure 20). It may be appreciated however that other closure means such as weatherstripping seals, hook and loop fasteners, interlocking cables, pneumatic pressure, heat, light, static electricity, strands, coils, peas shoot tendrils, friction fit and or adhesives/pre-backed adhesive strips, or the like could also be utilized. In the shown embodiment rear door 92 is a flap which can be moved to the closed position of FIG. 12, and to the open position of FIG. 13.

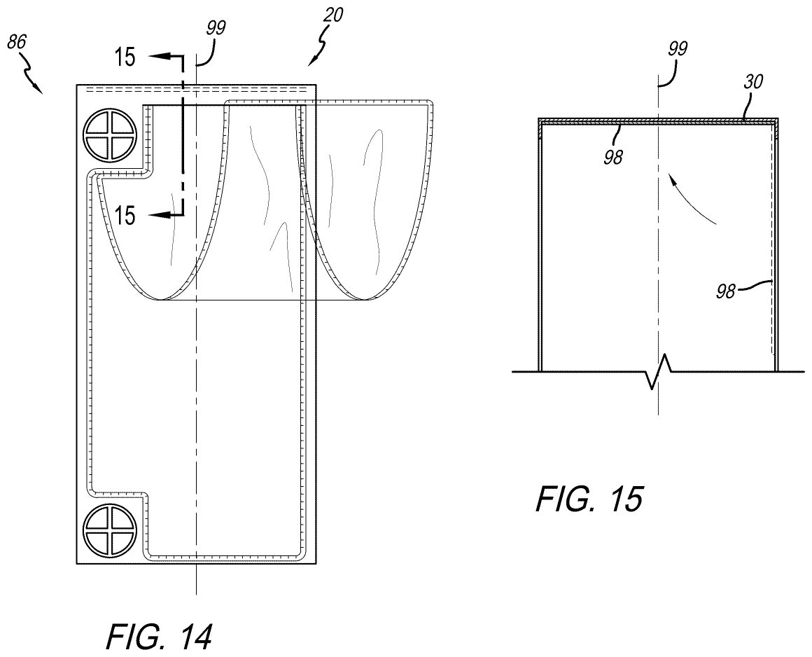

Referring to FIGS. 13-15 enclosure 20 has a longitudinal axis 99. A locking panel 98 is pivotally connected to at least one of top panel 30 and bottom panel 32 (in the shown embodiment to top panel 30). Locking panel 98 is positionable to an unlocked position parallel to longitudinal axis 99 as shown in FIG. 13, and to a locked position perpendicular to longitudinal axis 99 as shown in FIGS. 14 and 15. FIG. 15 is a cross sectional view which shows both the unlocked (broken lines) and locked positions of locking panel 98. In the locked position locking panel 98 serves to hold first side panel 22, second side panel 24 apart and therefore retain the cuboid shape of enclosure 20. This feature is similar to that of the bottom of a storage box which hold the shape of the box. It is noted that more than one locking panel 98 can be utilized in various positions.

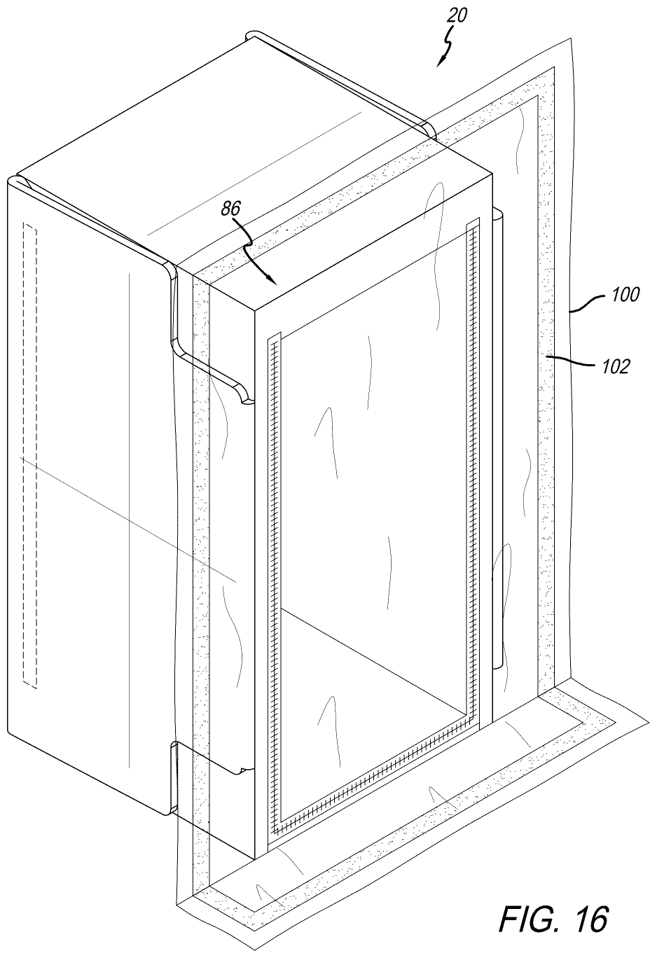

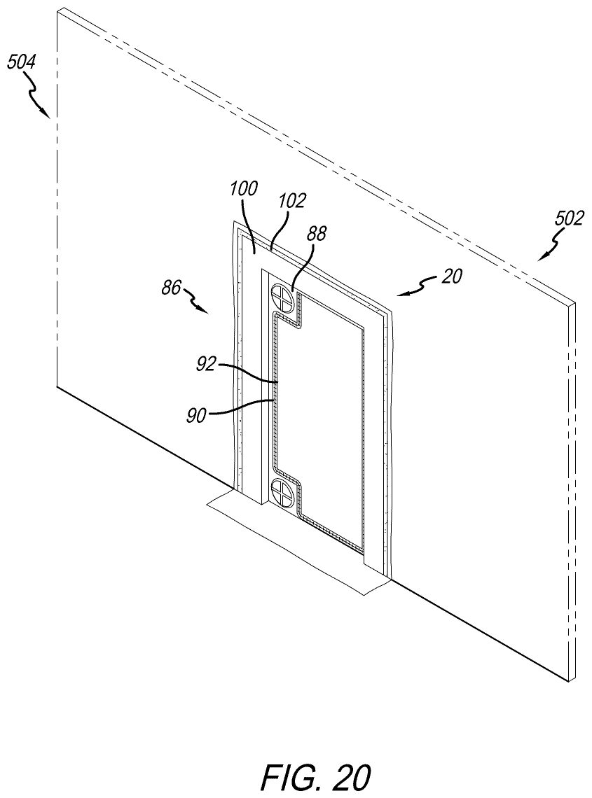

Referring to FIG. 16, a flexible flange 100 is disposed at and sealed to rear side 86 of enclosure 20. In an embodiment, flexible flange 100 is fabricated from a polymer sheeting. Flexible flange 100 includes an adhesive strip 102 at its perimeter which is connectable to entrance 500 (refer to FIG. 20). Flexible flange 100 extends around the perimeter of the rear side 86 of enclosure 20 and forms an adaptable pressure fit seal against existing surfaces around entrance 500 as is shown in FIG. 20. Adhesive strip 102 can include multiple peel-off layers of adhesive allowing multiple uses. In the shown embodiment adhesive strip 102 is only disposed on the rear side of flexible flange 100, but can also be provided on both sides of the perimeter of flexible flange 100.

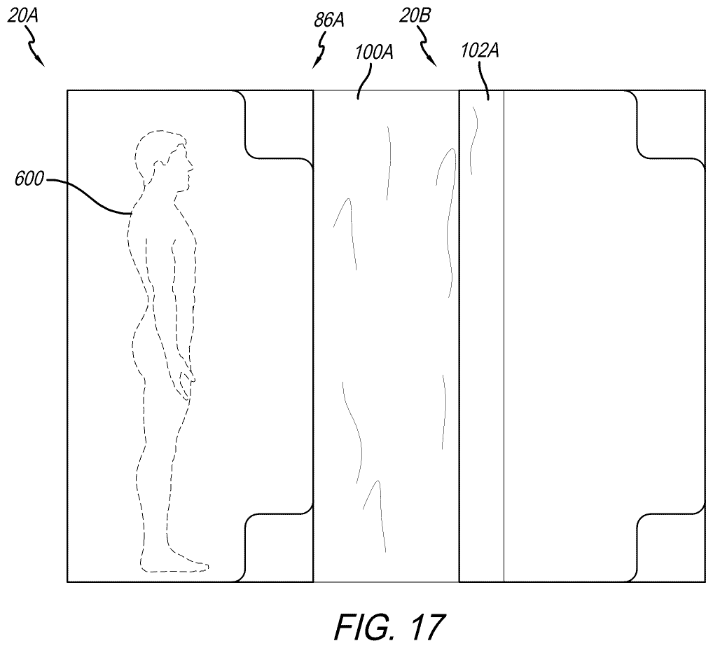

Now referring to FIG. 17, there is illustrated two enclosures 20A and 20B connected together. Flexible flange 100A is disposed at the rear side 86A of enclosure 20A and has and adhesive strip 102A. Flexible flange 100A of enclosure 20A is connected to enclosure 20B by flexible flange 102A to form an air tight expandable area, wall, or tunnel. This is helpful for double doors or other instances where there is need to expand the work area, create a tunnel or the entrance is irregular. A user 600 is shown inside enclosure 20A. It is understood that the enclosure could also be positioned laying resting on the side panel and suitable to receive a laying down human.

Now referring to FIGS. 18-20 there are illustrated reduced perspective views of enclosure 20 placed adjacent entrance 500. Entrance 500 has a clean side 502, a contaminated side 504 (the side of entrance 500 where contamination exists), and an opening 506 therebetween. Enclosure 20 is positioned adjacent entrance 500 at clean side 502 so that rear side 86 having rear wall 86 with closure 90 and rear door 92 abuts entrance 500 and enclosure 20 completely covers opening 506. Front side 66 having front wall 68 with closure 70 and front door 72 is postponed away from entrance 500, and is ready for a user to enter. It may be appreciated that opening 506 may have associated door(s), window(s), or other hardware. In the shown embodiment opening 506 is simply that an opening. In the shown embodiment a plurality of tethers 104 are utilized to firmly hold enclosure 20 in place against entrance 500. Tethers 104 are connected to enclosure 20 and connect (are tied) to a plurality of anchors 510 in entrance 500. Anchors 510 may be eyebolts or other hardware screwed into entrance 500, or may be existing hardware such as door hinges, ceiling bars, or the like. To seal enclosure 20. Flexible flange 100 includes an adhesive strip 102 which in the shown embodiment is connected to the contaminated side 504 of entrance 500 to effect an air tight seal. In the shown embodiment flexible flange 100 is positioned through opening 506 and adheres to the contaminated side 504 of entrance 500.

FIG. 21 is a reduced perspective view of enclosure 20 in the collapsed configuration. Enclosure 20 can be placed in the collapsed configuration by connecting a reversed blower to one of the enclosures service connection ports and removing the air from the enclosure (see discussions below). It is noticed tht first side panel 22 is folded on the center and angled fold lines.

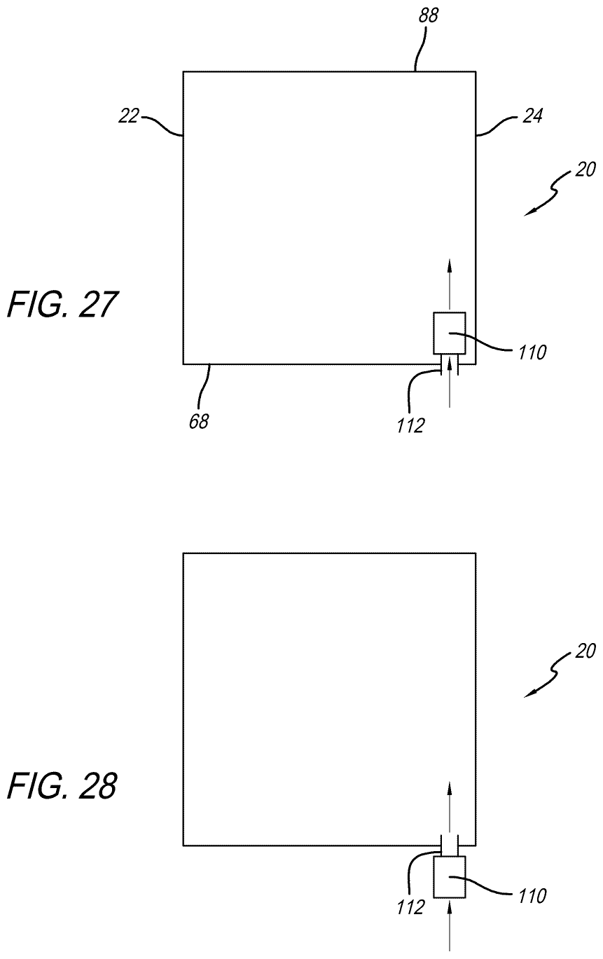

In FIG. 22 enclosure 20 has been folded one time from the collapsed configuration of FIG. 21, and though not shown in some embodiments can be folded even again. The folding results in a package which is easy to transport. From the folded configuration of FIG. 22, FIGS. 23-26 show the sequence of inflating enclosure 20 to the expanded configuration (FIG. 26). In an embodiment a blower 110 (refer to FIGS. 27-33) is utilized to effect the inflation of enclosure 20. Blower 110 is connected to a service connection point 112 (see FIGS. 27-33) and air is forced into enclosure 20 causing it to go from the collapsed configuration (FIG. 21) to the expanded configuration (FIG. 26).

Now referring to FIGS. 27-33 there are illustrated several air flow embodiments of enclosure 20 which ensure that contaminated air cannot enter the clean air side of an entrance 500. The intent of blower(s) 110 is to create a flow of air from the clean side (area) 502 of entrance 500 to the contaminated (dirty) side 504. Fresh air passes from clean side 502 to the contaminated side (area) 504, is filtered by filters in blower 110, and then exhausted into the dirty side 504. Provided that the amount of supply air and exhaust are balanced correctly, there will be a negative pressure differential achieved between the dirty area and the clean area, and where the airflow will be flowing from the clean area to the dirty area. Variable speed blowers are used to adjust the amount of supply and or exhaust air based on site conditions; this may include restricting or increasing the existing facility supply or exhaust air supplies. When the total amount of exhaust from the work area exceeds the supply, negative air pressure is achieved and where there is a negative pressure differential maintained between the clean side 502, into/through enclosure 20 into the contaminated side 504. This prevents a backflow of airborne contaminates from contaminated side 504 if the seal between the clean side 502 and contaminated side 504 were to be broken, or more normally when a person passes through enclosure 20 to work between the clean and contaminated spaces. In this way enclosure 20 acts as a anteroom airlock and physical barrier, sealing to the entrance of the contaminated side 504 and allowing for control of relative airflow/pressurization providing continuous conditioned air for workers inside the contaminated side 504. In the shown view enclosure 20 has first side panel 22, second side panel 24, front wall 68, and rear wall 88.

In a preferred embodiment of enclosure 20 one or more blowers 110 are built into enclosure 20. The blowers 110 include fan blades which can selectively rotate forward or backward as the situation may dictate. For example the fan blades of blower 110 rotate in one direction to inflate enclosure 20, and in the opposite direction during deflation. It can be appreciated that the same function can also be achieved by physically rotating a one way fan.

If no blowers 110 are built into enclosure 20, an external blower 110 may be connected for “manual” inflation at the @ primary service connection point (see discussion below) (Ref FIG. 27).

One or more service connection points 112 on enclosure 20 provide for a prescribed location to perforate the sealed cuboid and connect incoming and outgoing services with an air tight seal, such as for supply air intake, exhaust air out take and or pass through of other services such as, power cords, air sample hoses, suctions hoses, light strands, plumbing pipes and the like. In a primary embodiment, service connection points 112 (also refer to FIGS. 1 and 3) serve as ports for the passage of air entering or exiting enclosure 20. In the shown embodiment service connection point 112 includes a short sleeve to which air ducts can be easily connected. Various members of enclosure 20 may be pre-fit with connection points 112 that mate together to join and create a seal including with use of magnets, zippers, plastic sandwich bag seal, hook and loop, pneumatic pressure, heat, light, static electricity, strands, coils, peas shoot tendrils, friction fit and or adhesives/pre-backed adhesive strips. If a service connection point 112 is not being used, it can be left unperforated, capped or otherwise block to maintain the airtight seal of enclosure 20.

Blowers 110 provide supply and exhaust air, thus providing means of inflation (erecting), deflation (re-stowing) and full operation of air movement and filtering.

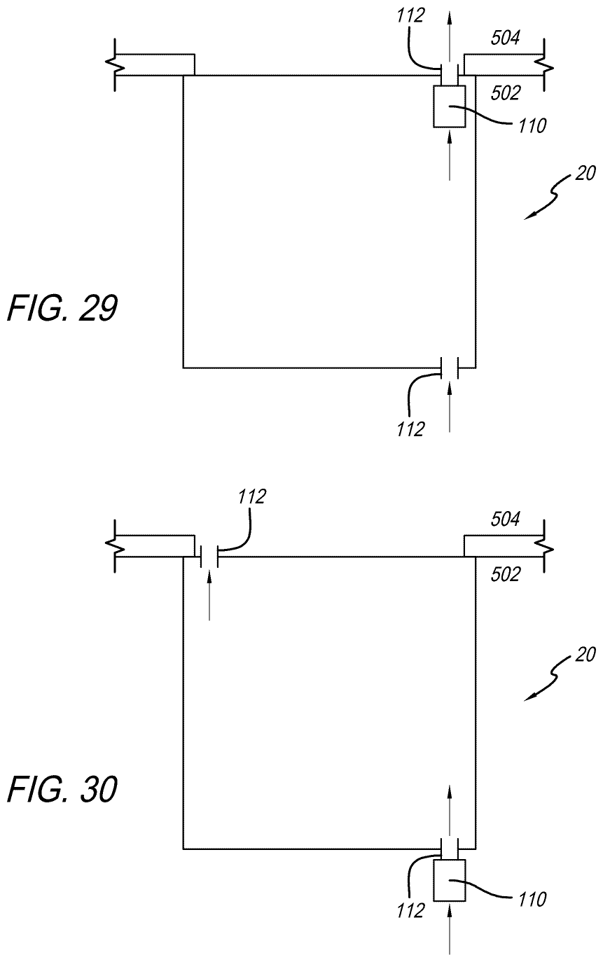

FIGS. 27 and 28 illustrate an external blower 110 and an internal blower 110 respectively being used to inflate enclosure 20. These figures (and FIGS. 29-33) are functional diagrams which show how air is routed into and out of enclosure 20. It may be appreciated that the number and location of the service connection points 112 on enclosure 20 may be varied to suit anticipated needs. Blower 110 may be connected internally to enclosure 20 as is shown in FIG. 27 or externally FIG. 28 at a service connection point 112. The shown airflow configuration is useful in inflating enclosure 20, or if the blower air flow is reversed, deflating enclosure 20.

Referring to FIG. 27, in an embodiment, enclosure 20 has a service connection point 112. An internal blower 110 is connected to service connection point 112. Internal blower 110 is useable to place enclosure 20 in the expanded configuration (refer to FIG. 1) or in the collapsed configuration (refer to FIG. 21). Referring to |FIG. 28, in another embodiment, enclosure 20 has a service connection point 112. An external blower 110 is connected to service connection point 112. External blower 110 is useable to place enclosure 20 in the expanded configuration (refer to FIG. 1) or the collapsed configuration (refer to FIG. 21). For deflation, blower 110 is reversed to create an outward airflow.

FIG. 29 shows another air flow embodiment. Enclosure 20 is sealed to the entrance of a contaminated area 504 and blower 110 exhausts air from clean area 502 along the sealed face from the enclosure 20 into contaminated area 504. Air flow is shown with arrows. A separate means of exhaust is required from within contaminated area 504 to maintain conditions.

FIG. 30 shows another air flow embodiment. Enclosure 20 is sealed to an entrance of a contaminated area 504. Blower 110 supplies fresh air from clean area 502 which passively exhausts into contaminated area 504.

A separate means of exhaust is required from within contaminated area 504 to maintain conditions.

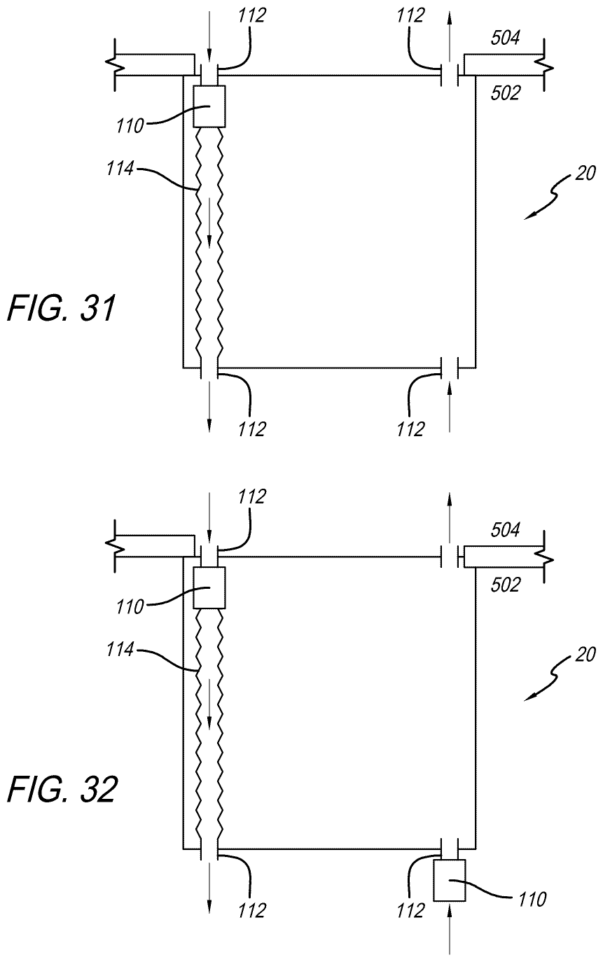

FIG. 31 shows another air flow embodiment. Enclosure 20 is sealed to an entrance of a contaminated area 504. A passive air supply (non-blown) supplies fresh air from clean area 502 to enclosure, and thence to contaminated area 504. Additionally a blower 110 draws filtered air from contaminated area 504 and delivers it via a duct 514 to clean area 502. This mode is advantageous when there is otherwise no means to exhaust air from within the contaminated area 504.

FIG. 32 shows another air flow embodiment. This embodiment is the same as the embodiment of FIG. 31 except that a blower also provides fresh air from clean area 502 to enclosure 20 which is then passively delivered to contaminated area 504. This mode is advantageous when there is no means to exhaust air from within contaminated area 504.

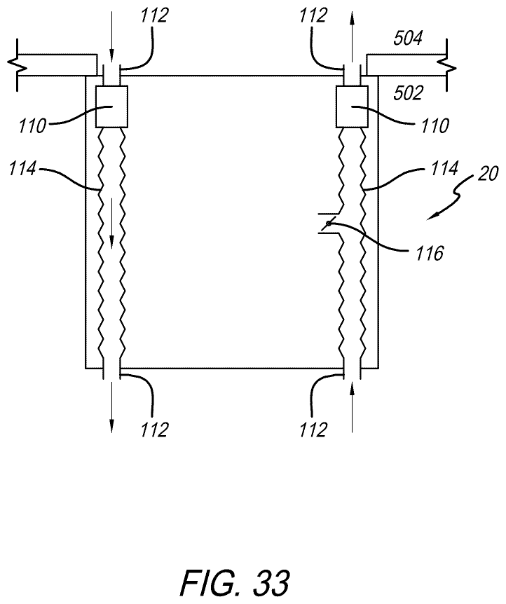

FIG. 33 shows another air flow embodiment. Enclosure 20 is sealed to an entrance of a contaminated area 504 with one blower 110 supplying fresh air from clean area 502 through duct 514 to contaminated area 504. A damper 116 may be used to control and balance the volume of air supply. Also a second blower 110 passes air from contaminated area 504 to clean area 502 via duct 514. This mode is advantageous when there is no means to exhaust air from within contaminated area 504 and where all fan equipment can be located within the contaminated area 504.

### Certain Features of the Containment Barrier

Features of some embodiments of enclosure 20 are described below:

A three-dimensional, six sided, monolithic folding cuboid which is able to transform from a articulated void cuboid form to a compact folded compressed form. The folding cuboid is constructed of six conjoined panels, fused together forming the six sides of the void cuboid shape. Panels include top panel, bottom panel, first side panel, second side panel, front panel, and rear panel.

The panels are imparted with a predefined folding pattern, allowing the completed six sided cuboid to fold and unfolded along the unified predetermined folding hinge pattern; the special mechanistical folds are able to articulate in a unified movement, and where they are able to “snap” between one desired form to the other multiple time through folded memory.

The first and second side panels fold in half horizontally and vertically, with triangular folds at each end allowing the panels to fold flat inward and where the side panels provide the main compressive function along the cuboid to be folded flat, thus allowing sufficient flatness for further folding in half along the predetermined pattern.

The top panel folds in half along the center and in alignment with the adjoining first and second side panels.

The bottom panel similarly folds in half along the center and in alignment with the adjoining first and second side panels.

The front and rear panels provide a “blank canvas” which may be customized with additional integral features and/or additional joining layers such as tape seal flange, locking panels, doors, windows, service connection points and other features, and provided they maintain the required seal, accommodate folding. In this way the folding cuboid is able to mechanically articulate between folded and unfolded form automatically by applying an expansive or compressive force uniformly along the body, such as by drawing from the center outwards at the top and bottom. In this way the sealed void shape may be also be exposed to an internal vacuum, allowing it to receive expansive or compressive forces, mainly with use of an onboard or external fan system.

The external or onboard blower (fan) may be provided at the service connection points (portals). In an embodiment there are two or more service connection points on the front panel. However it may be appreciated that service connection points may be located anywhere on the enclosure panels.

One or more locking panels may be provided in alignment with the front panel and folding action into alignment with the bottom, top, and/or first and second side panels. The locking panel(s) ensure that the cuboid form is mechanically locked in shape. Locking the shape is important as the on board fan systems are also in place to provide relative air pressurization/exposure to internal vacuum.

A front wall may be provided as an additional layer at the front side of the enclosure, and a rear wall may be provided at the rear side of the enclosure.

Folding ramps are available to fold out from the interior of the enclosure across the front and rear thresholds. The ramps may have peel and stick adhesive base to secure in place, and/or to collect dust and debris.

Tethers may be connected along the exterior of the enclosure to connect and secure to the entrance.

It may be appreciated that enclosure 20 may be combined with entrance 500 to form a containment barrier system.

In terms of use, a contamination barrier method includes:
(a) providing an entrance 500 having a clean side 502, a contaminated side 504, and an opening 506 therebetween;
(b) providing an enclosure 20 having a front side 66, a rear side 86, and a plurality of interconnected panels, the enclosure 20 having to an expanded configuration and a collapsed configuration, in the expanded configuration the enclosure 20 positionable to abut the entrance 500 and cover the opening 506;
(c) providing a blower 110, the blower 110 being one of (1) an internal blower 110 disposed withing the enclosure, and (2) an external blower 110;
(d) with the enclosure 20 in the collapsed configuration, using the blower110_to inflate the enclosure 20 to the expanded configuration; and,
(e) positioning the rear side 86 of the enclosure 20 adjacent the entrance 500 wherein the enclosure 20 covers the opening 506.

The contamination barrier method further including:
in the expanded configuration the enclosure 20 having a cuboid shape.

The contamination barrier method further including:
in (b), a flexible flange 100 disposed at the rear side 86 of the enclosure 20, the flexible flange 100 having an adhesive strip 102; and,
in (e), connecting the adhesive strip 102 to the entrance 500.

The contamination barrier method further including:
in (a), the entrance 500 having a plurality of anchors 510;
in (b), a plurality of tethers 104 connected to enclosure 20, and;
in (e) connecting the plurality of tethers 104 to the plurality of anchors 510.

The contamination barrier method further including:
in (b) the plurality of interconnected panels including a top panel 30 and a bottom panel 32;
in (b), a first pull cord 160 connected to top panel 30 and a second pull cord 162 connected to bottom panel 32; and,
during (d), simultaneously pulling on first pull cord 160 and the second pull cord 162.

While the preferred embodiment of the enclosure 20 deploys with the use of a power fan or blower, the enclosure 20 can also be deployed manually. Based on the geometric form of the folded outer shell, the enclosure can be manually transformed from the compact form to an expanded cuboid form by pulling apart the identified “pull cords” at the top and bottom panels, thus actuating the entire form (front, back and side panels) to an unfolded position.

FIGS. 21 and 26 illustrate the above cited pulling action. Because of the unique way the panels of enclosure 20 are folded, application of an outward force (shown by arrows) causes the panels to open in a single motion without multiple manipulations. As such, applying an outward force to the top 30 and bottom 32 panels facilitates the transition from the collapsed configuration to the expanded configuration. This feature is particularly useful if for some reason enclosure 20 is not absolutely air tight which degrades the inflation process. In one embodiment one of the pull cords is connected to a hanger and a downward force applied to the opposite cord.

The embodiments of the expandable structure, system, and method of use described herein are exemplary and numerous modifications, combinations, variations, and rearrangements can be readily envisioned to achieve an equivalent result, all of which are intended to be embraced within the scope of the appended claims. Further, nothing in the above-provided discussions of the expandable structure, system, and method of use should be construed as limiting the invention to a particular embodiment or combination of embodiments. The scope of the invention is defined by the appended claims.

1. An expandable structure comprising:
an enclosure having a plurality of interconnected panels;
said plurality of panels including a first side panel, a second side panel, a front panel, a rear panel, a top panel, and a bottom panel;
said enclosure having an expanded configuration and a collapsed configuration;
each said panel of said plurality of panels being directly and fixedly connected to at least one other panel of said plurality of panels in both said expanded configuration and in said collapsed configuration;
said enclosure having a longitudinal axis;
said front panel directly and fixedly connected to said first side panel by a first hinge which is disposed parallel to said longitudinal axis;
said rear panel directly and fixedly connected to said second side panel by a second hinge which is disposed parallel to said longitudinal axis;
said enclosure having a front side;
a front wall disposed at said front side, said front wall connected to said first side panel, said second side panel, said top panel, and said bottom panel;
said enclosure having a rear side; and,
a rear wall disposed at said rear side, said rear wall connected to said second side panel, said first side panel, said top panel, and said bottom panel;
said top panel directly and fixedly connected to said first side panel and to said second side panel in both said expanded configuration and said collapsed configuration; and,
said bottom panel directly and fixedly connected to said first side panel and to said second side panel in both said expanded configuration and said collapsed configuration.

2. The expandable structure according to claim 1 further including:
in said expanded configuration said enclosure having a cuboid shape.

3. The expandable structure according to claim 1 further including:
said enclosure having a service connection point;
an internal blower disposed within said enclosure;
said internal blower is connected to said service connection point; and,
said internal blower providing air to place said enclosure in said expanded configuration or in said collapsed configuration.

4. The expandable structure according to claim 1 further including:
said enclosure having a service connection point;
an external blower is connected to said service connection point; and,
said external blower providing air to place said enclosure in said expanded configuration or in said collapsed configuration.

5. (canceled)

6. The expandable structure according to claim 1 further including:
said first side panel, said second side panel, said front panel, said rear panel, said top panel, and said bottom panel each having at least one fold line;
said first side panel and said second side panel each having a central fold line having a first end and an opposite second end; and,
first and second angled fold lines emanating from said first end of said central fold line, and third and fourth angled fold lines emanating from said second end of said central fold line.

7. (canceled)

8. (canceled)

9. The expandable structure according to claim 1 further including:
said front panel having a hinged flap having a first connector;
said first connector removably connectable to said second side panel or to said first side panel; and,
said first connector being a hook and loop connector.

10. (canceled)

11. The expandable structure according to claim 1 further including:
said rear panel having a hinged flap having a second connector;
said second connector removably connectable to said first side panel or to said second side panel; and,
said second connector being a hook and loop connector.

12. The expandable structure according to claim 1 further including:
a locking panel;
said locking panel pivotally connected to at least one of said top panel and said bottom panel; and,
said locking panel positionable to an unlocked position parallel to said longitudinal axis, and to a locked position perpendicular to said longitudinal axis.

13. The expandable structure according to claim 1 further including:
a ramp pivotally connected to said bottom panel; and,
said ramp positionable to an inwardly projecting stowed position and to an outwardly projecting deployed position.

14. The expandable structure according to claim 13 further including
said ramp having a top surface; and,
a dust collector disposed on said top surface of said ramp.

15. The expandable structure according to claim 1 further including:
said bottom panel having a bottom side; and,
an adhesive disposed on said bottom side of said bottom panel.

16. The expandable structure according to claim 1 further including:
a front door disposed in said front wall.

17. The expandable structure according to claim 1 further including:
a rear door disposed in said rear wall.

18. The expandable structure according to claim 1, the expandable structure cooperating with an entrance, the expandable structure further including:
said enclosure having a rear side;
a flexible flange disposed at said rear side;
said flexible flange fabricated from a polymer sheet;
said flexible flange having an adhesive strip disposed at its perimeter; and,
said adhesive strip connected to the entrance to form a pressure seal.

19. The expandable structure according to claim 1, the expandable structure cooperating with an entrance, the expandable structure further including:
a plurality of tethers connected to said enclosure; and,
said plurality of tethers connectable to the entrance.

20. (canceled)

21. A contamination barrier system comprising:
an entrance having a clean side, a contaminated side, and an opening therebetween;
an enclosure having a front side, a rear side, and a plurality of interconnected panels;
said enclosure having an expanded configuration and a collapsed configuration; and,
in said expanded configuration said rear side of said enclosure positioned adjacent to said entrance wherein said enclosure covers said opening.

22. The contamination barrier system according to claim 21 further including:
in said expanded configuration said enclosure having a cuboid shape.

23. The contamination barrier system according to claim 21 further including:
said enclosure having a service connection point;
said enclosure including an internal blower which communicates with said service connection point; and,
said internal blower usable to place said enclosure in said expanded configuration or in said collapsed configuration.

24. The contamination barrier system according to claim 21 further including:
said enclosure having a service connection point;
an external blower which is connectable to said service connection point of said enclosure; and,
said external blower usable to place said enclosure in said expanded configuration or in said collapsed configuration.

25. The contamination barrier system according to claim 21 further including:
a flexible flange disposed at said rear side;
said flexible flange having an adhesive strip; and,
said adhesive strip connected to said entrance.

26. The contamination barrier system according to claim 21 further including:
a plurality of tethers connected to said enclosure;
said entrance having a plurality of anchors; and,
said tethers connected to said anchors.

27. A contamination barrier method comprising:
(a) providing an entrance having a clean side, a contaminated side, and an opening therebetween;
(b) providing an enclosure having a front side, a rear side, and a plurality of interconnected panels, said enclosure having an expanded configuration and a collapsed configuration, in said expanded configuration said enclosure positionable to abut said entrance and cover said opening;
(c) providing a blower, said blower being one of (1) an internal blower disposed within said enclosure, and (2) an external blower;
(d) with said enclosure in said collapsed configuration, using said blower to inflate said enclosure to said expanded configuration; and,
(e) positioning said rear side of said enclosure adjacent said entrance wherein said enclosure covers said opening.

28. The contamination barrier method of claim 27 further including:
in said expanded configuration said enclosure having a cuboid shape.

29. The contamination barrier method of claim 27 further including:
in (b), a flexible flange disposed at said rear side of said enclosure, said flexible flange having an adhesive strip; and,
in (e), connecting said adhesive strip to said entrance.

30. The contamination barrier method of claim 27 further including:
in (b) said plurality of interconnected panels including a top panel and a bottom panel;
in (b), a first pull cord connected to said top panel and a second pull cord connected to said bottom panel; and,
during (d), simultaneously pulling on said first pull cord and said second pull cord.

31. (canceled)

32. (canceled)

33. (canceled)

34. The expandable structure according to claim 1 further including:
said front panel having (1) a closed position disposed adjacent to and covering said front wall, and (2) an open position rotated away from and exposing said front wall; and,
said rear panel having (1) a closed position disposed adjacent to and covering said rear wall, and (2) an open position rotated away from and exposing said rear wall.

35. An expandable structure comprising:
an enclosure having a plurality of interconnected panels;
said plurality of panels including a first side panel, a second side panel, a front panel, a rear panel, a top panel, and a bottom panel;
said enclosure having an expanded configuration and a collapsed configuration;
each said panel of said plurality of panels being directly and fixedly connected to at least one other panel of said plurality of panels in both said expanded configuration and in said collapsed configuration;
said enclosure having a front side;
a front wall disposed at said front side, said front wall connected to said first side panel, said second side panel, said top panel, and said bottom panel;
said enclosure having a rear side;
rear wall disposed at said rear side, said rear wall connected to said second side panel, said first side panel, said top panel, and said bottom panel; and,
said first side panel, said second side panel, said top panel, said bottom panel, said front wall, and said rear wall forming a closed volume in both said expanded configuration and said collapsed configuration.

36. The expandable enclosure according to claim 35 further including:
said front wall fabricated from a polymer sheet; and,
said rear wall fabricated from a polymer sheet.

37. The expandable structure according to claim 35 further including:
said front panel having (1) a closed position disposed adjacent to and covering said front wall, and (2) an open position rotated away from and exposing said front wall; and,
said rear panel having (1) a closed position disposed adjacent to and covering said rear wall, and (2) an open position rotated away from and exposing said rear wall.
